(19) United States
(12) Patent Application Publication
(10) Pub. No.: US 2014/0191958 A1
(43) Pub. Date: Jul. 10, 2014

(54) CURSOR CONTROL METHOD FOR A TOUCH SCREEN

(71) Applicant: Wistron Corporation, New Taipei City (TW)

(72) Inventor: Hou-Cheng Chen, New Taipei City (TW)

(73) Assignee: Wistron Corporation, New Taipei City (TW)

(21) Appl. No.: 14/083,366

(22) Filed: Nov. 18, 2013

(30) Foreign Application Priority Data
Jan. 5, 2013 (CN) 201310002704.8

(51) Int. Cl. G06F 3/041; G06F 3/0481

(52) U.S. Cl. CPC G06F 3/041; G06F 3/0481
USPC 345/157

(57) ABSTRACT

When a cursor control mode of an electronic device is enabled, an arrow cursor is converted into a transparent ball on a touch screen and touch input at any area of the touch screen is simulated as a contact point of a tangent plane to a virtual sphere utilized to be forced to roll on a virtual surface with specific rolling direction and speed, as the touch input moves along a specific direction with a specific speed on the touch screen. The data of the rolling direction and speed of the virtual sphere will be converted to corresponding movements of the transparent ball on the touch screen. No direct contact to the transparent ball is needed to move the transparent ball and any target icon will not be blocked by fingers. Enlargement of the content covered by the transparent ball also facilitates easy reading and recognition.

### BACKGROUND OF THE INVENTION

1. Field of the Invention

The invention relates to an electronic control method, and more particularly, to a touch screen control method using simulation of a rolling ball as a cursor.

2. Description of the Prior Art

Although conventional cursor device such as a mouse, a tracking ball, or a touchpad, has brought a great convenience when it comes to operating a personal computer, touch control over personal computers or smart phones through a touch screen has taken up the main stream of development of human interface device. For those devices with both touch function and an arrow cursor provided on the touch screen, operating the arrow cursor on the touch screen by direct contact of the touch screen always gets the arrow cursor blocked in sight by the fingertip and not quite easy to be “moved” by the fingertip to a precise location on the touch screen. On the other hand, the touch screen for devices like the smart phones has followed the trend of increasing the resolution in such limited small size, which makes the target pixels also become smaller. Hence, it is getting harder operating on such devices by use of touch control than on a conventional computer display.

Some measures have been taken to deal with such problems by way of enlarging/reducing the entire screen to obtain a better targeting, i.e., the target pixels about to be touched/clicked is enlarged for some degree able to be operated and then ready to be touched by the user. Such measures, however, require cumbersome work of repetitively changing display scaling of the screen.

### SUMMARY OF THE INVENTION

To overcome the problem, the invention replaces a conventional cursor on the screen with a transparent ball and makes use of optical and moving properties of a virtual crystal sphere to provide an instinctive experience of operating a cursor on the screen for an user and provide a new touch control experience using an cursor on the touch screen without dramatically changing the way a user used to do.

According to the purpose, the invention provides a cursor control method for a touch screen. The method includes steps: enabling a cursor control mode on the touch screen to convert a first graphical object to a second graphical object and providing the second graphical object on the touch screen; and performing a touch input on the touch screen and the second graphical object correspondingly moving on the touch screen according to the touch input received by the touch screen.

According to the cursor control method, the method further includes step: providing the first graphical object on the touch screen.

According to the cursor control method, the first graphical object is a two-dimensional planar object and the second graphical object is a three-dimensional object.

According to the cursor control method, the first graphical object is an arrow cursor and the second graphical object is a transparent ball.

According to the cursor control method, the second graphical object correspondingly moving on the touch screen according to the touch input received by the touch screen is the second graphical object rolling on the touch screen.

According to the cursor control method, the method further includes step: displaying the content on the touch screen covered by the second graphical object in an enlarging way with a specific enlarging scale.

According to the cursor control method, the method further includes steps: during the touch input on the touch screen, reducing the second graphical object and reducing the specific enlarging scale to display the content on the touch screen covered by the second graphical object when two or more than two touch points approach one another; and enlarging the second graphical object and increasing the specific enlarging scale to display the content on the touch screen covered by the second graphical object when two or more than two touch points part from one another.

According to the cursor control method, the second graphical object correspondingly moves on the touch screen according to the movement of a geometric center of a plurality of touch points received by the touch screen.

According to the cursor control method, performing a touch input on the touch screen is performing the touch input at an area on the touch screen other than area covered by the second graphical object.

According to the cursor control method, the touch input comprising data of moving direction, moving speed, and moving acceleration of a touch point, and the second graphical object moving correspondingly on the touch screen according to the data of moving direction, moving speed, and moving acceleration of the touch point.

According to the cursor control method, enabling a cursor control mode on the touch screen is enabling the cursor control mode by performing a specific touch gesture on the touch screen.

According to the cursor control method, the method further includes steps: the touch screen providing a first physical effect when the second graphical object passes through a first content area of the touch screen; and the touch screen providing a second physical effect when the second graphical object passes through a second content area of the touch screen. Either the first physical effect or the second physical effect is selected from one of the following: vibrating the touch screen, sounding, increasing moving resistance to the second graphical object, reducing moving resistance to the second graphical object, and bouncing the second graphical object on the touch screen.

According to the cursor control method, the touch screen further provides icons of a plurality of applications. The cursor control method further includes steps: providing a bouncing effect to the second graphical object when the second graphical objects passes through an icon of one of the applications; and displaying the icon of the application covered by the second graphical object in an enlarging way.

According to the cursor control method, the method further includes step: the touch screen providing a resistance effect opposite in direction to the movement of the second graphical object and the resistance effect stops the movement of the second graphical object when the touch screen no longer receives the touch input.

According to the cursor control method, the mouse cursor in a conventional sense is converted into the transparent spherical ball and touch input at any area of the touch screen may be simulated as a contact point of a tangent plane to a virtual sphere corresponding to the transparent ball and utilized to be forced to roll. In such way, no direct contact to the transparent ball is needed to move the transparent ball toward any targeted icon that will not be blocked by fingers.

Meanwhile, the transparent ball has its magnifying ability to enlarge the text and pattern beneath and display them on the surface, which guides the user to focus right onto it and be able to move the transparent ball to the right position precisely. For electronic devices with small size, high resolution touch display, and its target pixels being too small for normal operation, the invention provides easy, instinctive, and precise way of cursor control for the user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of an electronic device having a touch screen.

FIG. 2 is an illustration of the electronic device displaying the desktop with a cursor control mode enabled.

FIG. 3 is an illustration showing a concept of the cursor control method of the invention.

FIG. 4 is an illustration providing a flow chart of a cursor control method according to the invention.

FIG. 5 is an illustration showing an embodiment implementing the cursor control method of the invention on a touch screen.

FIG. 6 is an illustration of another embodiment implementing the cursor control method of the invention on the touch screen 20.

### DETAILED DESCRIPTION

Certain terms are used throughout the following description and claims to refer to particular system components. As one skilled in the art will appreciate, manufacturers may refer to a component by different names. In the following discussion and in the claims, the terms “include” and “comprise” are used in an open-ended fashion. Also, the term “couple” is intended to mean either an indirect or direct electrical connection. Thus, if a first device is coupled to a second device, that connection may be through a direct electrical connection, or through an indirect electrical connection via other devices and connections.

In the embodiments of the invention, an arrow cursor on a desktop of a touch screen of an electronic device such as a mobile portable device, a digital tablet computer, a laptop computer with touch function, or a monitor, will be replaced with a three-dimensional object or a transparent ball on the touch screen, and movements of touch points on the touch screen is simulated to have physical behavior of a virtual sphere rolling on a surface, i.e., the transparent ball may be controlled by the touch points to be “rolled” on the touch screen and the area covered by the transparent ball may also be enlarged.

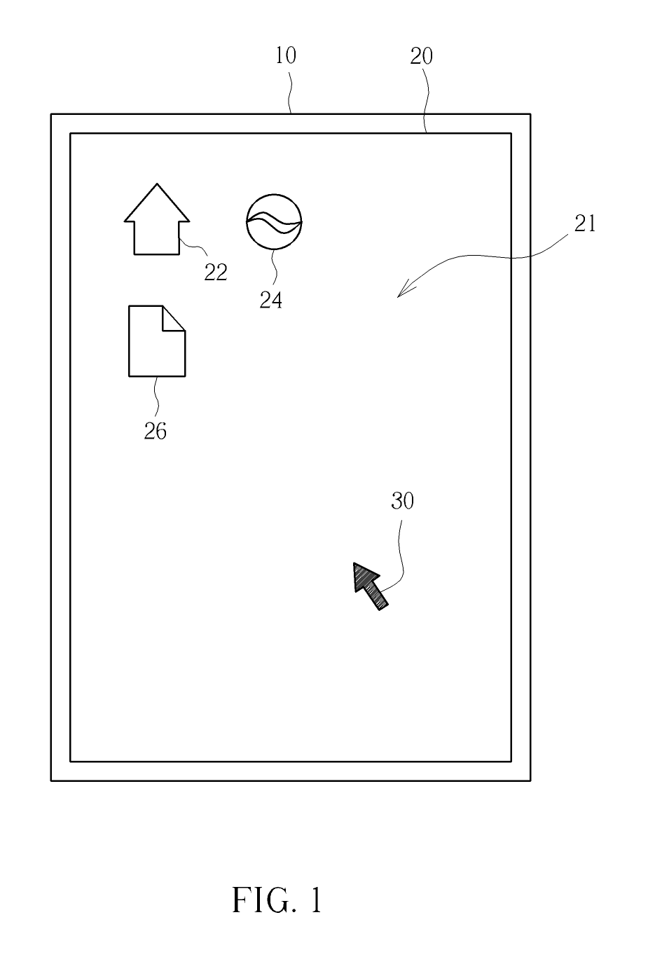

Please refer to FIG. 1. FIG. 1 is an illustration of an electronic device having a touch screen. An electronic device 10 includes a touch screen 20 where a desktop 21 of the touch screen 20 includes one or more icons 22, 24, 26 representing a number of applications. An arrow cursor 30 in the desktop 21 may be moved either by a pointing device such as a mouse or a keyboard, or by direct contact to the touch screen 20. An application linked to one of the icons 22, 24, 26 can be executed by moving the arrow cursor 30 to one of the icons 22, 24, 26 and clicking on the touch screen 20.

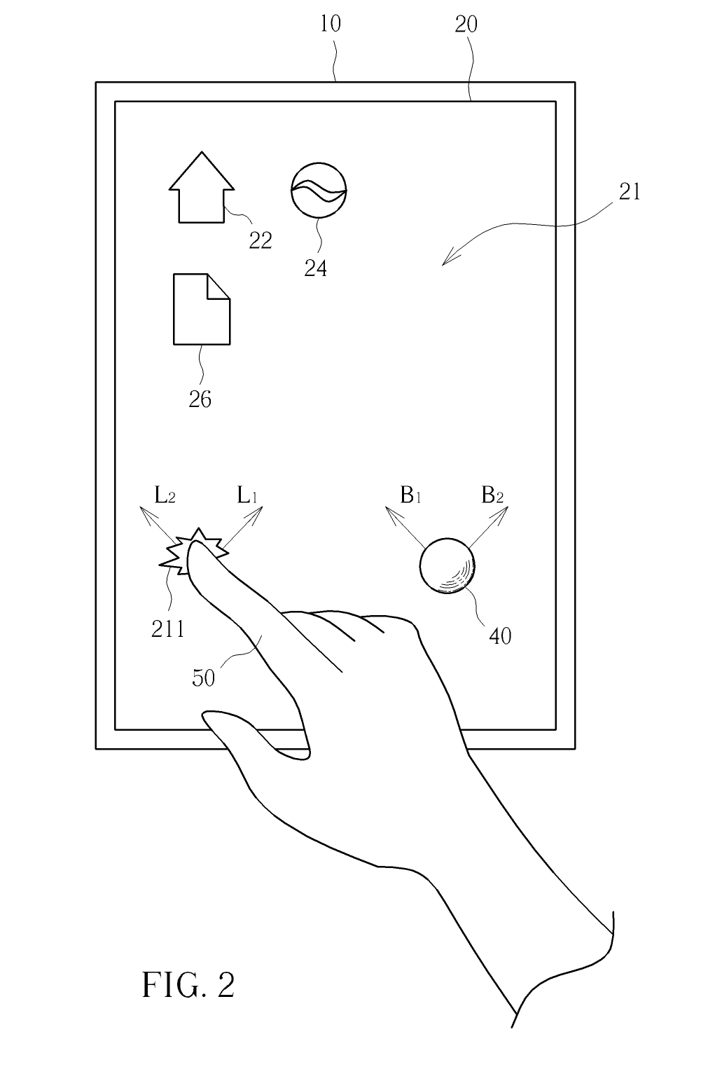

Please refer to FIG. 2. FIG. 2 is an illustration of the electronic device displaying the desktop with a cursor control mode enabled. A cursor control method is provided in the application to facilitate more instinctive and convenient cursor control of the touch screen 20. When the cursor control mode is enabled, the arrow cursor 30, if any, of the touch screen 20 will be converted into a transparent ball 40, which is simulated as a crystal sphere. The transparent ball 40 may also be directly provided to the touch screen 20 if no arrow cursor previously existed. In the cursor control mode, a user 50 touching a touch point 211 on the touch screen 20 to perform a touch input and moving the touch point 211 along direction L₁ or L₂ is able to have direct control over the transparent ball 40 to roll on the desktop 21 along direction B₁ or B₂.

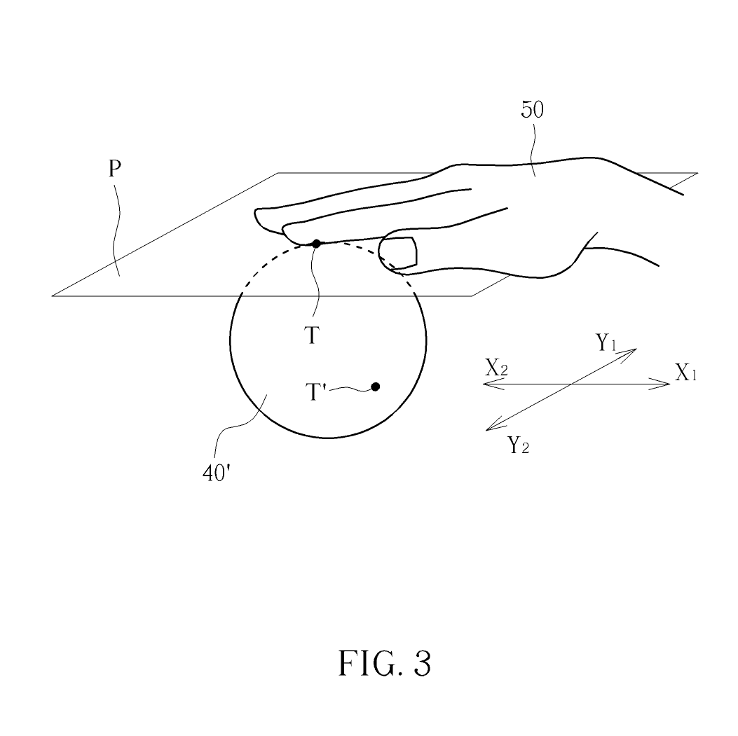

Please refer to FIG. 3, which is an illustration showing a concept of the cursor control method of the invention. The invention provides a way of converting the arrow cursor 30 into a transparent ball 40, by means of simulating the transparent ball 40 as an operable crystal sphere on the touch screen 20, which can be rolled to the target pixels instead of using direct contact the target pixels by the fingertip. It provides not only a simulated physical behavior of rolling a sphere on a surface to achieve the objective of moving an object on the touch screen but a close experience to a real operation of rolling a sphere.

Referring FIG. 3, a sphere 40′ maybe forced to roll or to change its rolling movement by being exerted with force along a specific direction. The force exerted on the sphere 40′ stands for a directional vector of force. For example, as the user 50 contacts the surface of the sphere 40′ from right above and forces to roll the sphere 40′, the tangent plane including the contact between the user 50 and the sphere 40′ will change from a tangent plane P to another. These tangent planes always are perpendicular to the direction of gravity, which means the user 50 always has contact with the surface of the sphere 40′ on the plane formed by the axis X₁X₂ and the axis Y₁Y₂. Moreover, the time spent from one tangent plane P to another tangent plane denotes the rolling speed of the sphere 40′. Each tangent plane P has contact with the surface of the sphere 40′ at a contact T on the sphere 40′, meaning each contact T on the sphere 40′ correspondingly denotes a tangent plane P. Hence, the direction from one contact T to another contact T′ on the surface of the sphere 40′ denotes the rolling direction of the virtual sphere 40′. The rolling direction and the rolling speed (and the rolling acceleration may be included) of the sphere 40′ provide necessary data for generating instructions for controlling the movement of the transparent ball 40 on the touch screen 20.

According to such concept, the desktop 21 of the touch screen 20 is regarded as the surface of the palm of the user 50 to operate the sphere 40′ and any one touch point such as the touch point 211 in FIG. 2 on the desktop 21 is treated as a contact T of the sphere 40′ in contact with the surface of the palm. Once the cursor control mode is enabled to display what is shown in FIG. 2, the user 50′s sliding touch on the desktop 21 with his fingertip generates touch input, which will be analyzed to produce data with information of speed, direction, and acceleration that correspond to the simulated information as produced in FIG. 3.

It should be noted that when the transparent ball 40 is controlled under the cursor control mode as in FIG. 2, touch input at any area of the desktop 21 of the touch screen 20 generates the needed control data. In other words, with the cursor control mode as shown in FIG. 2, the user 50 may freely touch any area of the desktop 21, either directly at the transparent ball 40 or areas except for the transparent ball 40 such as the touch point 211, and be able to touch and control the transparent ball 40 directly.

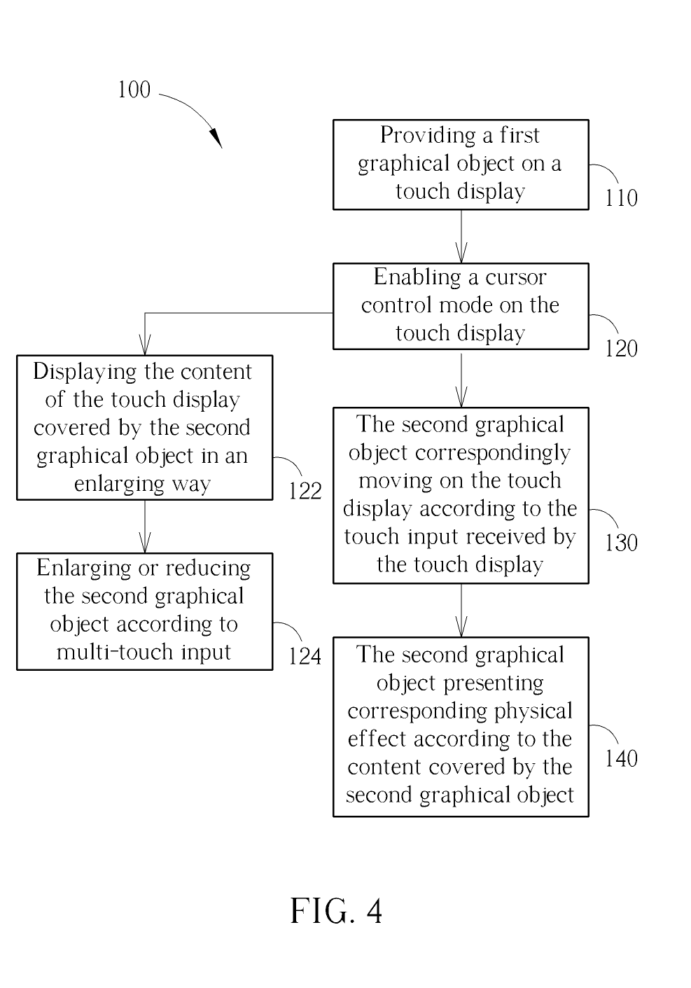

Please refer to FIG. 4. FIG. 4 is an illustration providing a flow chart of a cursor control method according to the invention. A cursor control method 100 includes following steps:

Step 110: providing a first graphical object on a touch screen;

Step 120: enabling a cursor control mode on the touch screen to convert the first graphical object to a second graphical object and providing the second graphical object on the touch screen;

Step 122: displaying the content of the touch screen covered by the second graphical object in an enlarging way with a specific enlarging scale;

Step 124: performing multi-touch input on the touch screen to enlarge or reduce the second graphical object according to the multi-touch input;

Step 130: performing a touch input on the touch screen and the second graphical object correspondingly moving on the touch screen according to the touch input received by the touch screen;

Step 140: the second graphical object presenting corresponding physical effect according to the content covered by the second graphical object on the touch screen.

In Step 110, a first graphical object is provided on the touch screen 20. The first graphical object may be the arrow cursor 30 noted earlier or cursor in other form, which is generally a two-dimensional planar object. For some electronic devices, the first graphical object or the arrow cursor 30 may also be an optional configuration and not necessarily provided on the touch screen 20. In Step 120, the cursor control mode may be enabled either by performing a movement of the arrow cursor 30 along a specific route on the touch screen 20 using the mouse or the keyboard, or a specific touch gesture directly contacting the touch screen 20 or moving the arrow cursor 30 on the touch screen 30, or operating the pointing device or touching the touch screen 20 to move the arrow cursor 30 to a specific corner, boundary edge of the desktop 21.

Additionally, as for the embodiment that does not have the first graphical object or the arrow cursor 30, the transparent ball 40 may also be pre-settled in a corner or a boundary edge of the desktop 21 of the touch screen 20, whereas moving the transparent ball 40 by touching the transparent ball 40 out of the corner or the boundary edge of the desktop 21 may also be implemented as a way of enabling the cursor control mode in the invention. Moreover, the cursor control mode may be disabled when none of the operations as in Step 122, 124, 130 takes place within a predetermined period of time and the cursor control method 100 gradually moves the transparent ball 40 to the corner or the boundary edge of the desktop 21 to disable the cursor control mode.

As the cursor control mode is enabled for the touch screen 20, the electronic device 10 provides the second graphical object (such as the transparent ball 40) converting from the first graphical object (the arrow cursor 30) or directly appearing on the desktop 21. The second graphical object maybe showing up on the desktop 21 in a form of three-dimensional object but not limited to such in the invention. Both the first graphical object and the second graphical object may be either two-dimensional planar object or three-dimensional object.

It should be noted that since the second graphical object is implemented as a three-dimensional transparent ball 40, the transparent ball 40 will provide effect as a magnifying glass to display the content, text or patterns, covered by the second graphical object (or beneath the second graphical object) in an enlarging way and show it up on the surface of the transparent ball 40 enlarged with a specific enlarging scale as described in Step 122.

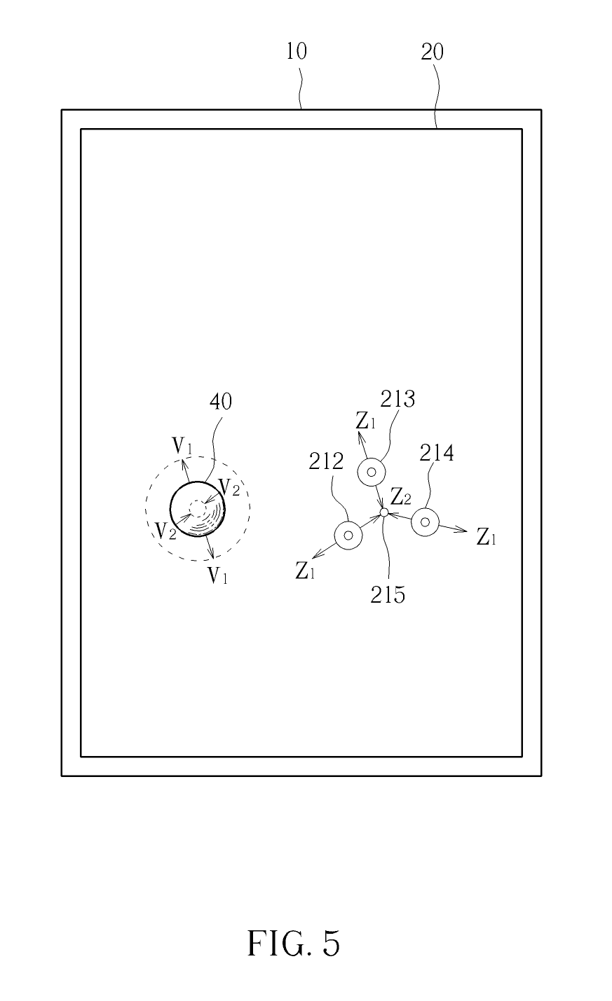

Please refer to FIG. 5 altogether. FIG. 5 is an illustration showing an embodiment implementing the cursor control method of the invention on a touch screen 20. The cursor control method of the invention provides control over the transparent ball 40 that does not have to touch or click the transparent ball 40 directly on the touch screen 20. As a result, Step 124 describes a touch input on the touch screen 20 with multiple touch points moving at the same time on the touch screen 20 to further manipulate the size of the transparent ball 40 and the enlarging scale the transparent ball 40 has over the area it covers. For example, two or more touch points 212, 213, 214 approaching one another along direction Z₂ causes reduction of the size of the transparent ball 40 along direction V₂ and also reduces the enlarging scale to display the content on the touch screen 20 covered by the transparent ball 40. Similarly, two or more touch points 212, 213, 214 parting from one another along direction Z₁ causes enlarging of the size of the transparent ball 40 along direction V₁ and also increases the enlarging scale to display the content on the touch screen 20 covered by the transparent ball 40.

As previously described, the cursor control method 100 of the invention makes operation to move the transparent ball 40 possible with the need of direct touch or click on the transparent ball 40 and this is detailed in Step 130. Hence, touch input like the touch point 211 in FIG. 2 at any area of the desktop 21 of the touch screen 20 generates a signal and according to such, the second graphical object moves correspondingly on the desktop 21 of the touch screen 20. Moreover, the transparent ball 40 as the realization of the second graphical object may be rolling on the touch screen 20 as its preferable movement so as to simulate the real physical property of a virtual sphere 40′ moving on a surface.

Additionally, each of the touch inputs generated by sliding on the touch screen 20 maybe analyzed to produce data of moving speed, direction, and acceleration, and performing touch input on the touch screen 20 means the touch point 211 occurred at any area of the desktop 21 of the touch screen 20 produces data of moving direction, moving speed, and moving acceleration, whereas the second graphical object will be rolling correspondingly on the touch screen 20 according to the data of moving direction, moving speed, and moving acceleration.

Additionally, Step 130 also provides that when two or more touch points 212, 213, 214 exist and move as in FIG. 5, the transparent ball 40 correspondingly moves or rolls on the touch screen 20 according to the movement, having parameters of direction, speed, and acceleration, of a simulated touch point 215 of a geometric center of the touch points 212, 213, 214.

Since the transparent ball 40 provides effect as a magnifying glass to display the content, the transparent ball 40 displays the content of the target pixels in an enlarging way with a specific enlarging scale when controlled to roll to some target pixels as in Step 130, thus the transparent ball 40 may be positioned precisely to any target pixels. Hence, the invention is well applicable to provide accurate touch positioning on electronic devices 10 with small size, high resolution touch display.

Additionally, in the process of displaying the area covered by the second graphical object in an enlarging way with a specific enlarging scale as in Step 122, the “optical” enlarging scale may vary from the edge of the transparent ball 40, increasing gradually or nonlinearly, toward the center of the transparent ball 40. This brings out a seamless transition between the enlarged text/pattern within the transparent ball 40 and the not enlarged text/pattern outside the transparent ball 40.

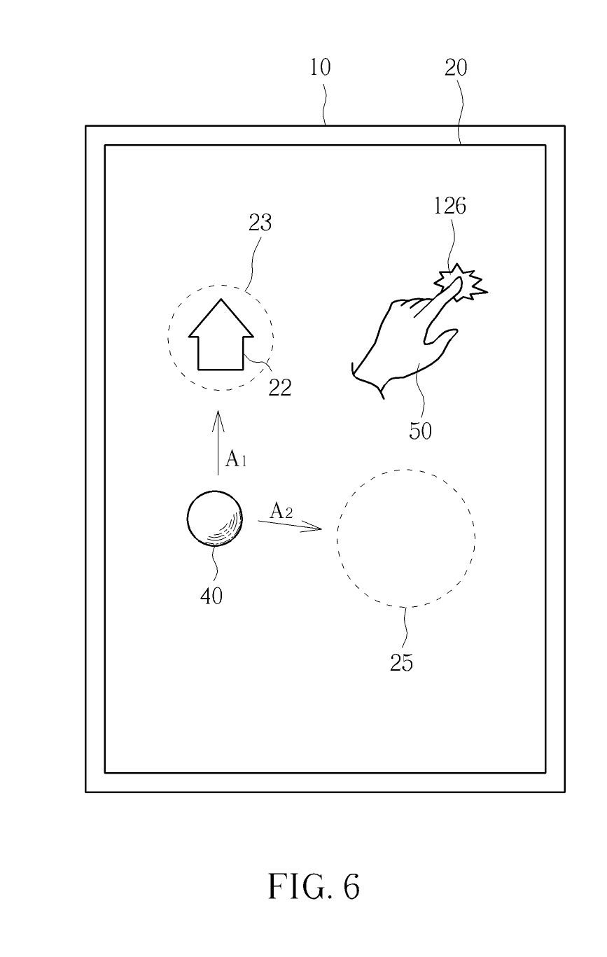

Next in Step 140, the cursor control method 100 further provides various physical effects according to the content covered or passed through by the second graphical object on the touch screen 20. Please refer to FIG. 6, which is an illustration of another embodiment implementing the cursor control method of the invention on the touch screen 20. Also referring to FIG. 3, the sphere 40′ may encounter different physical effects when passing through different surfaces. For example, the “weight” of the sphere 40′ has influence on how the speed of the sphere 40′ may vary when exerted with external force and the physical expression F=Ma (F denotes the force exerted to the sphere 40′, M denotes the mass of the sphere 40′, and a denotes the acceleration the sphere 40′ has due to the external force) is applicable on the movement of the sphere 40′ with which the moving direction, the moving speed, and the moving acceleration come.

Likewise, the transparent ball 40 on the touch screen 20 will be moved with the moving direction, the moving speed as described in Step 130, and furthermore, the transparent ball 40 may have its mass given according to the its size that is determined in Step 124. The variation of speed of sliding on the touch screen 20 by the user 50 may be utilized to denote the force exerted on the transparent ball 40 such that the movement of the transparent ball 40 comes with the acceleration property.

Additionally, when the transparent ball 40 is controlled to roll through areas on the desktop 21 of the touch screen 20, corresponding responses maybe provided according to the content area on the desktop 21. For example, say, a first content area 23 of the desktop 21 includes the icon 22 and when the transparent ball 40 passes through the first content area 23, the touch screen 20 provides a first physical effect such as bouncing the transparent ball 40 on the touch screen 20, the transparent ball 40 “trapped” in a hole, vibrating the touch screen 20, or sounding accordingly, etc. When the transparent ball 40 passes through a second content area 25, which might be a flat surface or a rugged road surface with some texture based on the pattern of the desktop 21, the touch screen 20 provides a second physical effect such as bouncing the transparent ball 40 on the touch screen 20, the transparent ball 40 “trapped” in a hole, vibrating the touch screen 20, sounding accordingly, the transparent ball 40 mildly bouncing according to the “texture” of the surface, or increasing/decreasing moving resistance to the transparent ball 40.

In such way, Step 140 provides a specific effect like one of those mentioned previously or any other possible way to implement on the device when the transparent ball 40 passes through any one of icons 22, 24, 26 on the desktop 21. These clear physical effects may further facilitate precise positioning of the transparent ball 40 to the target pixels even for small icon configuration. Besides the physical effects, the magnifying property of the transparent ball also lets the user 50 identify the icons 22, 24, 26 more conveniently.

Additionally, moving the transparent ball 40 to simulate the sphere 40′ rolling on a surface also means that the transparent ball 40 may inherit the friction property, including static friction and dynamic friction, having “contact” with the desktop 21 and the friction differs when moving the transparent ball 40 over different content areas. In other words, the simulation of friction provides a resistance effect opposite in direction to the movement of the transparent ball 40 such that the user 50 would have to constantly “force” the transparent ball 40 to keep mobilizing the transparent ball 40, and as the “force” exerted on the transparent ball 40 by the user 50 no longer exists, the transparent ball 40 will slow down gradually due to the friction and stop eventually.

In the embodiments provided by the invention, when the cursor control mode of the electronic device 10 is enabled, the arrow cursor 30 is converted into the transparent ball 40 on the touch screen 20 and touch input at any area of the touch screen 20 is simulated as a contact point of a tangent plane to the virtual sphere 40′ utilized to be forced to roll on a virtual surface with specific rolling direction and speed, as the touch input moves along a specific direction with a specific speed on the touch screen 20. The data of the rolling direction and speed of the virtual sphere 40′ will be converted to corresponding movements of the transparent ball 40 on the touch screen 20. No direct contact to the transparent ball 40 is needed to move the transparent ball 40 and any target icon will not be blocked by fingers. Enlargement of the content covered by the transparent ball 40 also facilitates easy reading and recognition.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A cursor control method for a touch screen, comprising steps:
enabling a cursor control mode on the touch screen to convert a first graphical object to a second graphical object and providing the second graphical object on the touch screen; and
performing a touch input on the touch screen and the second graphical object correspondingly moving on the touch screen according to the touch input received by the touch screen.

2. The cursor control method of claim 1, further comprising step:
providing the first graphical object on the touch screen.

3. The cursor control method of claim 2, wherein the first graphical object is a two-dimensional planar object and the second graphical object is a three-dimensional object.

4. The cursor control method of claim 2, wherein the first graphical object is an arrow cursor and the second graphical object is a transparent ball.

5. The cursor control method of claim 4, wherein the second graphical object correspondingly moving on the touch screen according to the touch input received by the touch screen is the second graphical object rolling on the touch screen.

6. The cursor control method of claim 3, further comprising step:
displaying the content on the touch screen covered by the second graphical object in an enlarging way with a specific enlarging scale.

7. The cursor control method of claim 3, further comprising steps:
during the touch input on the touch screen, reducing the second graphical object and reducing the specific enlarging scale to display the content on the touch screen covered by the second graphical object when two or more than two touch points approach one another; and
enlarging the second graphical object and increasing the specific enlarging scale to display the content on the touch screen covered by the second graphical object when two or more than two touch points part from one another.

8. The cursor control method of claim 1, wherein the second graphical object correspondingly moves on the touch screen according to the movement of a geometric center of a plurality of touch points received by the touch screen.

9. The cursor control method of claim 1, wherein performing a touch input on the touch screen is performing the touch input at an area on the touch screen other than area covered by the second graphical object.

10. The cursor control method of claim 1, wherein the touch input comprising data of moving direction, moving speed, and moving acceleration of a touch point, and the second graphical object moving correspondingly on the touch screen according to the data of moving direction, moving speed, and moving acceleration of the touch point.

11. The cursor control method of claim 1, wherein enabling a cursor control mode on the touch screen is enabling the cursor control mode by performing a specific touch gesture on the touch screen.

12. The cursor control method of claim 1, further comprising steps:
the touch screen providing a first physical effect when the second graphical object passes through a first content area of the touch screen; and
the touch screen providing a second physical effect when the second graphical object passes through a second content area of the touch screen;
wherein either the first physical effect or the second physical effect is selected from one of the following: vibrating the touch screen, sounding, increasing moving resistance to the second graphical object, reducing moving resistance to the second graphical object, and bouncing the second graphical object on the touch screen.

13. The cursor control method of claim 1, wherein the touch screen further provides icons of a plurality of applications, the cursor control method further comprising steps:
providing a bouncing effect to the second graphical object when the second graphical objects passes through an icon of one of the applications; and
displaying the icon of the application covered by the second graphical object in an enlarging way.

14. The cursor control method of claim 1, further comprising step:
the touch screen providing a resistance effect opposite in direction to the movement of the second graphical object and the resistance effect stops the movement of the second graphical object when the touch screen no longer receives the touch input.
